(19) United States
(12) Patent Application Publication
(10) Pub. No.: US 2011/0141962 A1
(43) Pub. Date: Jun. 16, 2011

(54) METHOD AND APPARATUS FOR DEMODULATING MULTICAST SIGNAL

(75) Inventors: Jun-Woo Kim, Daejeon (KR); Young Jo Bang, Daejeon (KR); Youn Ok Park, Daejeon (KR)

(73) Assignee: Electronics and Telecommunications Research Institute, Daejeon (KR)

(21) Appl. No.: 12/868,164

(22) Filed: Aug. 25, 2010

(30) Foreign Application Priority Data
Dec. 15, 2009 (KR) 10-2009-0124791

(51) Int. Cl. H04H 20/71

(52) U.S. Cl. 370/312

(57) ABSTRACT

An apparatus for demodulating signals received from a plurality of base stations including a serving base station and a neighbor base station determines start timings of a serving cell signal transmitted from the serving base station and neighbor cell signals transmitted from the neighbor base stations, and verifies whether or not the neighbor cell signals that are earlier than the serving cell signal are provided on the basis of the determined start timings. Next, the apparatus selects a section where the reception energy of the symbol has the maximum level among symbols corresponding to signals of frames corresponding to the signals, respectively, as a demodulation section, and demodulates a multicast signal including the received signals on the basis of the selected demodulation section.

### CROSS-REFERENCE TO RELATED APPLICATION

This application claims priority to and the benefit of Korean Patent Application No. 10-2009-0124791 filed in the Korean Intellectual Property Office on Dec. 15, 2009, the entire contents of which are incorporated herein by reference.

### BACKGROUND OF THE INVENTION

(a) Field of the Invention

The present invention relates to an apparatus and a method for demodulating a multicast signal. More particularly, the present invention relates to an apparatus and a method for demodulating a multicast signal in a terminal.

(b) Description of the Related Art

In a wireless multicast/broadcast service, a plurality of base stations synchronize and transmit the same data. At this time, a terminal can continuously receive the service from the plurality of base stations without passing an additional network entry procedure.

A collection of base stations that transmit the same multicast information is referred to as a multicast broadcast service zone (MBS Zone).

A plurality of base stations that exist in one MBS zone transmit the same data by using the same symbol and subcarrier. Then, a terminal receiving the same data can acquire a macro-diversity effect.

When the terminal is positioned in a shadow area, the terminal receives a signal through a repeater. At this time, the terminal may receive a signal that a base station of a cell where the terminal itself is positioned transmits later than a signal that a base station of another adjacent cell due to a reception delay caused by the repeater transmits.

In this case, the terminal cannot acquire the macro-diversity effect.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an apparatus and a method for demodulating a multicast signal received from a terminal in order to acquire a macro-diversity effect.

An exemplary embodiment of the present invention provides a method for demodulating a signal received from a plurality of base stations including a serving base station and a neighbor base station, that includes:

determining start timings of a serving cell signal transmitted from the serving base station and neighbor cell signals transmitted from the neighbor base stations; verifying whether or not the neighbor cell signals that are earlier than the serving cell signal are provided on the basis of the start timings; selecting a section where the reception energy of the symbol has a maximum level among symbols corresponding to signals, as a demodulation section on the basis of the verification result; and demodulating a multicast signal included in the received signal on the basis of the demodulation section.

Another embodiment of the present invention provides an apparatus for demodulating signals received from a plurality of base stations including a serving base station and a neighbor base station, that includes:

a synchronization module that verifies whether or not the signals transmitted from the plurality of base stations are received by a terminal and determines start timings of the signals transmitted from the plurality of base stations; a control module selecting a demodulation section on the basis of the start timings of the signals; and a demodulation module demodulating a multicast signal included in the received signals on the basis of the demodulation section.

### BRIEF DESCRIPTION OF THE DRAWINGS

FIG. 1 is a diagram schematically showing a status in which macro-diversity of a multicast is adopted according to an embodiment of the present invention;

FIG. 2 is a diagram illustrating a case in which a terminal receives a signal of a serving base station later than a signal of an adjacent base station according to an embodiment of the present invention;

FIGS. 3A to 3D are diagrams illustrating a demodulating method depending on an arrival time of energy and a signal that a terminal receives according to an embodiment of the present invention;

FIG. 4 is a block diagram illustrating an apparatus for demodulating a multicast signal in a terminal according to an embodiment of the present invention; and

FIG. 5 is a flowchart illustrating a method for demodulating a multicast signal in a terminal according to an embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, unless explicitly described to the contrary, the word “comprise” and variations such as “comprises” or “comprising” will be understood to imply the inclusion of stated elements but not the exclusion of any other elements.

In the specification, a terminal may designate a mobile station (MS), a mobile terminal (MT), a subscriber station (SS), a portable subscriber station (PSS), user equipment (UE), an access terminal (AT), etc., and may include the entire or partial functions of the mobile station, the mobile terminal, the subscriber station, the portable subscriber station, the user equipment, the access terminal, etc.

In the specification, a base station (BS) may designate an access point (AP), a radio access station (RAS), node B, an evolved node-B (eNB), a base transceiver station (BTS), a mobile multihop relay (MMR)-BS, etc., and may include the entire or partial functions of the access point, the radio access station, the node B, the eNB, the base transceiver station, the MMR-BS, etc.

Hereinafter, an apparatus and a method for modulating a multicast signal according to an embodiment of the present invention will be described in detail with reference to the accompanying drawings.

A multicast according to the embodiment of the present invention is a method of simultaneously transmitting data to a plurality of receivers of a predetermined group, and a unicast is a method of transmitting data to only one predetermined receiver.

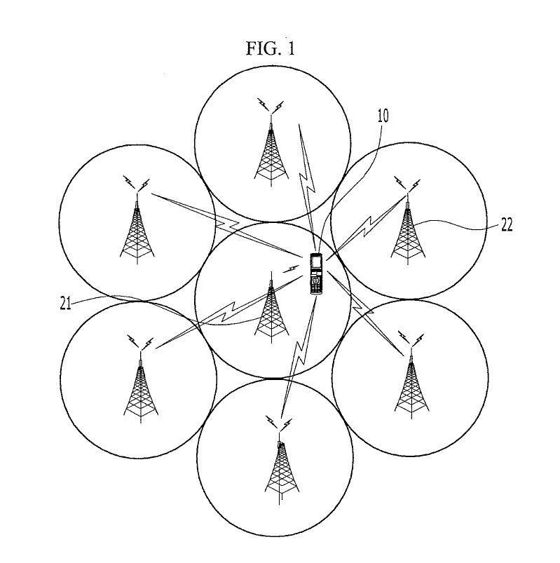

FIG. 1 is a diagram schematically showing a status in which macro-diversity of a multicast is adopted according to an embodiment of the present invention.

Referring to FIG. 1, one terminal 10 receives the same signal from a plurality of base stations to acquire a macro-diversity effect. At this time, a collection of the plurality of base stations is referred to as an MBS zone, and they transmit the same multicast information.

The plurality of base stations include a base station (hereinafter referred to as “serving base station”) 21 positioned in a serving cell, and a base station (hereinafter referred to as “neighbor base station”) 22 positioned in a neighbor cell. Herein, the serving base station 21 is a base station from which the terminal currently receives a service. Further, the neighbor base station 22 is a base station neighboring the serving base station 21.

An orthogonal frequency division multiplexing (hereinafter referred to as “OFDM”) system (not shown) prevents inter-symbol interference (ISI) and inter-carrier interference (ICI) by inserting a cyclic prefix (hereinafter referred to as “CP”) into each OFDM symbol (hereinafter referred to as “symbol”). Herein, the CP copies a predetermined part of a rear part of the symbol to a front part of the symbol. At this time, the length of the predetermined part is determined based on a radius of a cell that one base station takes charge of.

An OFDM receiving device (not shown) performs demodulation through the fast Fourier transform (FFT) between a CP start time of the received symbol and a first sample where the CP ends and the symbol begins. Then, the OFDM receiving device can perform demodulation without inter-carrier interference (ICI).

On the contrary, in the environment adopting the macro-diversity of the multicast, the length of existing CP is not sufficient, because each base station needs to transmit multicast data to a terminal positioned in another cell.

Accordingly, a multicast symbol adopts greater power and longer CP than the known symbol.

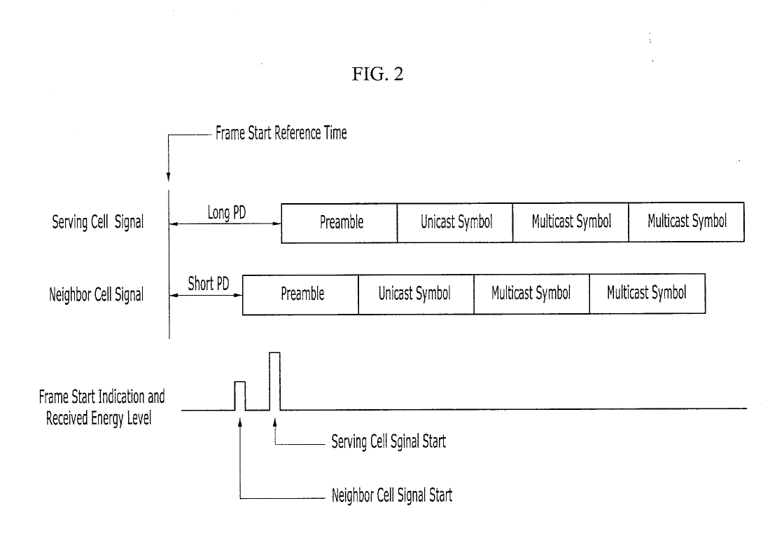

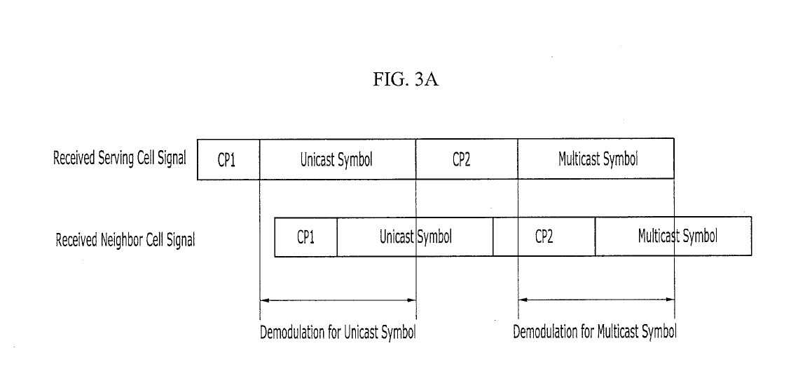

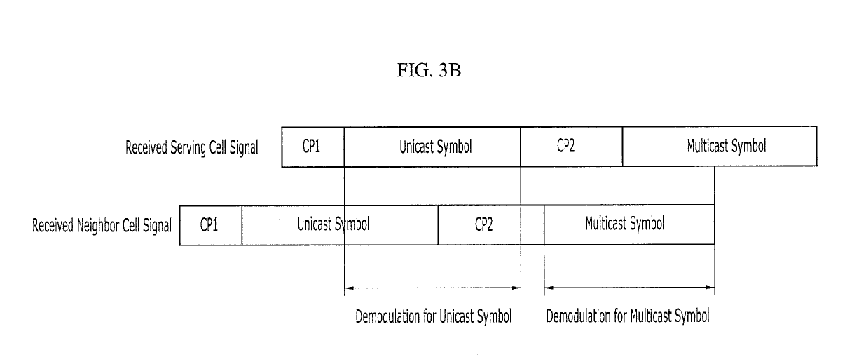

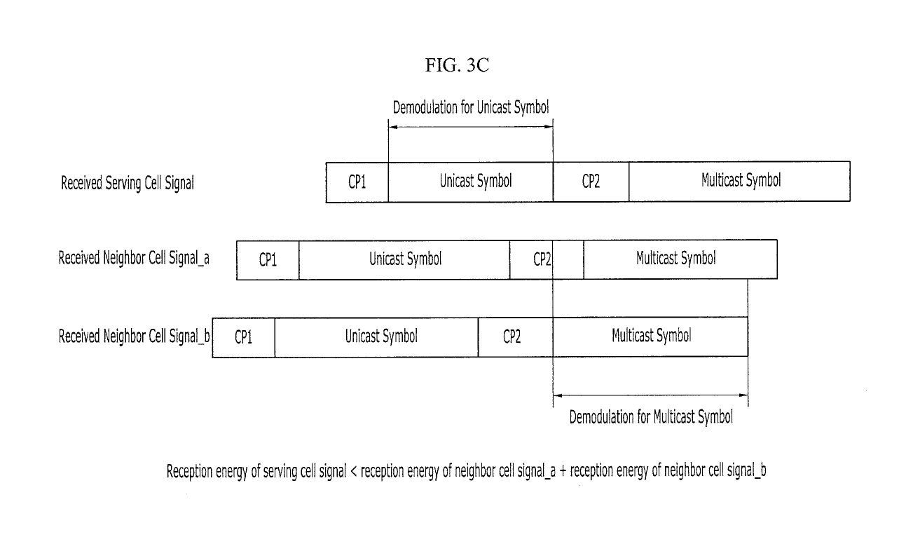

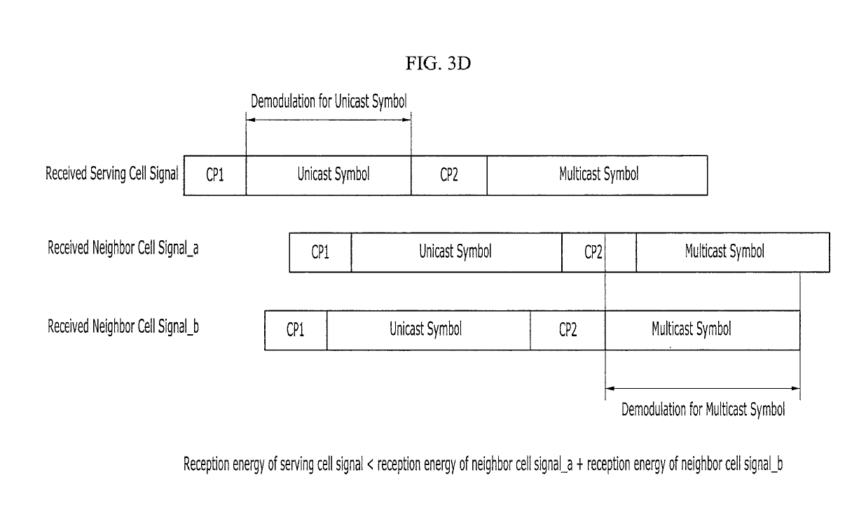

Next, a case in which the terminal according to the embodiment of the present invention receives the signal of the serving base station 21 later than the signal of the neighbor base station 22 and a demodulating method depending on an arrival time of energy and a signal in the terminal receiving the signal will be described in detail with reference to FIG. 2 and FIGS. 3A to 3D.

FIG. 2 is a diagram illustrating a case in which a terminal receives a signal of a serving base station later than a signal of an adjacent base station according to an embodiment of the present invention, and FIGS. 3A to 3D are diagrams illustrating a demodulating method depending on an arrival time of energy and a signal that a terminal receives according to an embodiment of the present invention.

Referring to FIG. 2, the terminal receives a signal (hereinafter referred to as “serving cell signal”) that the serving base station 21 transmits later than a signal (hereinafter referred to as “neighbor cell signal”) that the neighbor base station 22 transmits. At this time, reception energy of the serving cell signal is greater than reception energy of the neighbor cell signal.

The serving base station 21 transmits the serving cell signal to the terminal 10 after a first transmission delay (a long propagation delay) from a frame start reference time. On the contrary, the neighbor base station 22 transmits the neighbor cell signal to the terminal 10 after a second transmission delay (short propagation delay) that is shorter than the first transmission delay from the frame start reference time.

Each of frames corresponding to the serving cell signal and the neighbor cell signal includes a preamble, one unicast symbol, and at least one multicast symbol.

At this time, a demodulation performing time of a unicast signal corresponding to the unicast symbol and a multicast signal corresponding to the multicast symbol is determined as the case may be.

Referring to FIGS. 3A to 3D, a unicast CP is a CP1, and a multicast CP is a CP2. At this time, the CP1 and the CP2 according to the embodiment of the present invention may have the same length, or the CP2 may be longer than the CP1.

A terminal positioned in a predetermined cell may receive the unicast signal from the serving base station 21 to which the terminal itself belongs, and may receive the multicast signal transmitted by all base stations in an MBS zone.

In general, the terminal receives the serving cell signal that the serving base station 21 transmits earlier than the neighbor cell signal that the neighbor base station 22 transmits among a plurality of multicast signals received from the plurality of base stations.

For example, as shown in FIGS. 3A and 3D, the terminal may receive the serving cell signal earlier than the neighbor cell signal. On the contrary, as shown in FIGS. 3B to 3C, the terminal 10 may receive the serving cell signal later than the neighbor cell signal.

FIG. 3B illustrates the case in which the serving cell signal is received later than the neighbor cell signal. Further, FIG. 3C illustrates a case in which the serving cell signal is received later than the neighbor cell signal, the sum of reception energies of the neighbor cell signals is larger than reception energy of the serving cell signal, and the serving cell signal and the neighbor cell signals cannot be simultaneously demodulated without the inter-symbol interference (ISI).

FIG. 3D illustrates a case in which the serving cell signal is received earlier than the neighbor cell signal, the sum of reception energies of the neighbor cell signals is larger than the reception energy of the serving cell signal, and the serving cell signal and the neighbor cell signals cannot be simultaneously demodulated without the inter-symbol interference (ISI).

Referring to FIG. 3A, the terminal 10 demodulates the multicast signal in synchronization with the serving cell signal to acquire a macro-diversity effect.

For example, the terminal 10 is positioned in a shadow area to receive the serving cell signal through a repeater (not shown). At this time, the terminal 10 may receive the serving cell signal later than a signal of another neighbor cell, that is, the neighbor cell signal, due to a delay caused by the repeater, as shown in FIG. 2.

When the multicast signal is demodulated in synchronization with the serving cell signal, the multicast signals that the neighbor base stations 22 transmit cannot acquire the macro-diversity and cause inter-symbol interference.

Therefore, an apparatus for demodulating the multicast signal verifies whether or not the neighbor cell signal that is earlier than the serving cell signal is provided, and when the neighbor base station is provided in the same MBS zone, the demodulating apparatus can acquire the macro-diversity effect by selecting appropriate demodulation timing. Further, the apparatus for demodulating the multicast signal performs modulation of the unicast signal that the terminal receives on the basis of timing to start to receive the serving cell signal.

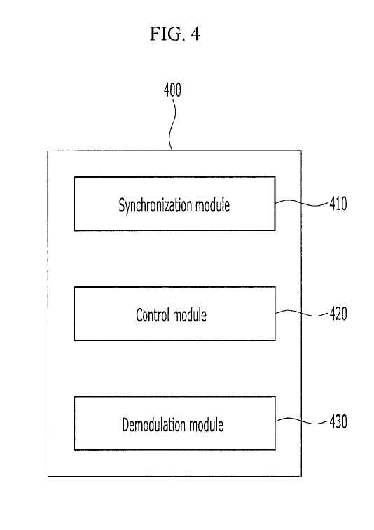

Next, the apparatus for demodulating the multicast signal that the terminal receives according to the embodiment of the present invention will be described in detail with reference to FIG. 4.

FIG. 4 is a block diagram illustrating an apparatus for demodulating a multicast signal in a terminal according to an embodiment of the present invention.

Referring to FIG. 4, a multicast signal demodulating apparatus 400 includes a synchronization module 410, a control module 420, and a demodulation module 430.

The synchronization module 410 determines start timing of the signal of at least one base station among the plurality of base stations positioned in the MBS zone and acquires the reception energy of the signal.

Specifically, the synchronization module 410 determines whether the start timing is the start timing of the frame corresponding to the serving cell signal that the serving base station 21 transmits or the start timing of the frame corresponding to the neighbor cell signal that the neighbor base station 22 positioned in the same MBS zone transmits. Further, the synchronization module 410 verifies and transmits whether or not the neighbor cell signal is received earlier than the serving cell signal on the basis of the determined frame start timing to the control module 420.

In general, a module receiving the signals that the plurality of base stations transmit can find start timing of the signals on the basis of training symbols such as preambles included in the received signals.

That is, the synchronization module 410 according to the embodiment of the present invention can determine whether the signals received from the plurality of base stations are the signals received from the serving base station 21 or the signals received from the neighbor base station 22 through a frequency domain pattern of the preamble included in each received signal, but is not limited thereto.

The control module 420 determines a demodulation section on the basis of the verification result of the synchronization module 410.

Specifically, when the neighbor cell signal is received earlier than the serving cell signal, the control module 420 selects a section where the reception energy has the maximum level among symbols of frames corresponding to each of the neighbor cell signal and the serving cell signal as the demodulation section. At this time, the demodulation section includes a first demodulation section demodulating the unicast symbol (demodulation for unicast symbol) and a second demodulation section demodulating the multicast symbol (demodulation for multicast symbol) among the symbols of the frames corresponding to each of the neighbor cell signal and the serving cell signal.

For example, when demodulation including the serving cell signal is most effective, the control module 420 selects the first demodulation section demodulating the unicast symbol and the second demodulation section demodulating the multicast symbol in each frame corresponding to the serving cell signal, as shown in FIG. 3B.

The control module 420 selects the demodulation section as shown in FIGS. 3C and 3D when the sum of the reception energies of the neighbor cell signals (neighbor cell signal_a and neighbor cell signal_b of FIGS. 3C and 3D) is larger than the reception energy of the serving cell signal.

Further, the control module 420 selects a section where the sum of the reception energies of the symbol has the maximum value as the demodulation section as shown in FIGS. 3C and 3D when the serving cell signal is temporally far earlier or later than the neighbor cell signals.

On the contrary, when the neighbor cell signal is received earlier than the serving cell signal, the control module 420 selects a corresponding symbol of the serving cell signal as the demodulation section on the basis of the start timing of the serving cell signal. For example, the control module 420 selects the first demodulation section demodulating the unicast symbol and the second demodulation section demodulating the multicast symbol in each frame corresponding to the serving cell signal, as shown in FIG. 3A.

The demodulation module 430 demodulates the multicast signal on the basis of the selected demodulation section to maximize the reception energy.

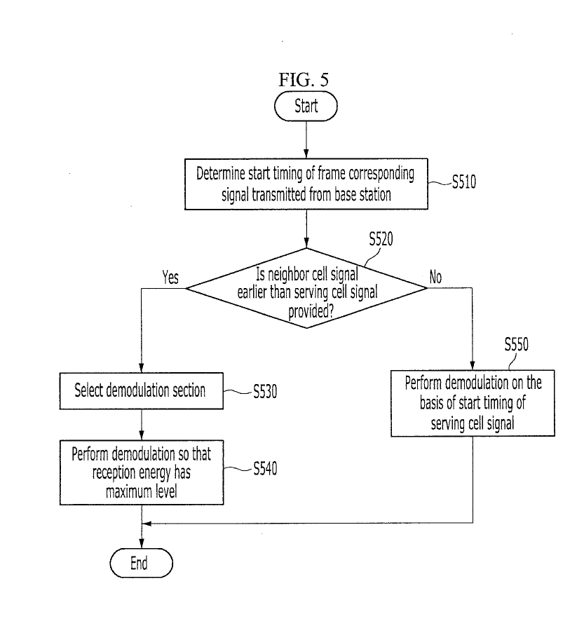

Next, a method for demodulating a multicast signal that a terminal receives according to an embodiment of the present invention will be described in detail with reference to FIG. 5.

FIG. 5 is a flowchart illustrating a method for demodulating a multicast signal in a terminal according to an embodiment of the present invention.

First, the terminal 10 according to the embodiment of the present invention receives a serving cell signal that a serving base station 21 transmits and a neighbor cell signal that a neighbor base station 22 transmits.

A multicast signal demodulating apparatus 400 that operates in link with the terminal 10 can demodulate the multicast signal on the basis of the serving cell signal and the neighbor cell signal.

Referring to FIG. 5, the multicast signal demodulating apparatus 400 verifies whether signals transmitted from base stations positioned in an MBS zone are received to determine start timings of the signals transmitted from the base stations (S510). At this time, the multicast signal demodulating apparatus 400 receives the signals transmitted from the base stations and determines whether or not the received signals are the start timing of the serving cell signal transmitted from the serving base station 21 or the start timing of the neighbor cell signal transmitted from the neighbor base station 22 positioned in the same MBS zone.

The multicast signal demodulating apparatus 400 verifies whether or not the neighbor cell signal that is earlier than the serving cell signal is provided on the basis of the determined start timing of the signal (S520).

According to the verification result, when the neighbor cell signal is received earlier than the serving cell signal, the multicast signal demodulating apparatus 400 selects a first demodulation section demodulating a unicast symbol and a second demodulation section demodulating a multicast symbol among symbols of frames corresponding to the neighbor cell signal and the serving cell signal, respectively (S530). At this time, the multicast signal demodulating apparatus 400 selects a section where the reception energy of the symbol has the maximum level among the symbols of the frames corresponding to the signals, respectively, as a demodulation section.

The multicast signal demodulating apparatus 400 demodulates the multicast signal on the basis of the selected demodulation section to maximize the reception energy (S540).

When the serving cell signal is received earlier than the serving cell signal, the multicast signal demodulating apparatus 400 selects the demodulation section of the symbol on the basis of the start timing of the serving cell signal, and demodulates the unicast signal and the multicast signal on the basis of the selected demodulation section (S550). Specifically, the multicast signal demodulating apparatus 400 selects the first demodulation section demodulating the unicast symbol and the second demodulation section demodulating the multicast symbol in the frame corresponding to the serving cell signal. Next, the multicast signal demodulating apparatus 400 performs demodulation in each of the first demodulation section and the second demodulation section.

Accordingly, the apparatus and method for demodulating the multicast signal according to the embodiment of the present invention can acquire the macro-diversity effect even when the terminal receives the neighbor cell signal from the neighbor base station earlier than the serving cell signal from the serving base station.

The above-mentioned exemplary embodiments of the present invention are not embodied only by an apparatus and method. Alternatively, the above-mentioned exemplary embodiments may be embodied by a program performing functions that correspond to the configuration of the exemplary embodiments of the present invention, or a recording medium on which the program is recorded. These embodiments can be easily devised from the description of the above-mentioned exemplary embodiments by those skilled in the art to which the present invention pertains.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for demodulating a signal received from a plurality of base stations including a serving base station and a neighbor base station, comprising:
determining start timings of a serving cell signal transmitted from the serving base station and neighbor cell signals transmitted from neighbor base stations;
verifying whether or not a neighbor cell signal that is earlier than the serving cell signal are provided on the basis of the start timings;
selecting a section where the reception energy of the symbol has a maximum level among symbols corresponding to signals, as a demodulation section on the basis of the verification result; and
demodulating a multicast signal included in the received signal on the basis of the demodulation section.

2. The method of claim 1, wherein
the selecting the demodulation section includes,
when the neighbor cell signal is received earlier than the serving cell signal:
selecting a section where reception energy of a unicast symbol has the maximum level among symbols of frames corresponding to the serving cell signal and the neighbor cell signal, as a first demodulation section; and
selecting a section where the reception energy of a multicast symbol has the maximum level among symbols of frames corresponding to the serving cell signal and the neighbor cell signal, as a second demodulation section.

3. The method of claim 2, wherein
the selecting the demodulation section includes
selecting a section where the reception energy of each of the unicast symbol and the multicast symbol among the symbols of the frames corresponding to the serving cell signal and the neighbor cell signals, has the maximum level when the sum of reception energies of the neighbor cell signals is larger than the reception energy of the serving cell signal.

4. The method of claim 1, wherein
the selecting the demodulation section includes
selecting the demodulation section of the symbol on the basis of the start timing of the serving cell signal when the neighbor cell signal is received earlier than the serving cell signal.

5. The method of claim 3, further comprising:
selecting a third demodulation section demodulating the unicast symbol in the frame corresponding to the serving cell signal; and
selecting a fourth demodulation section demodulating the multicast symbol in the frame corresponding to the serving cell signal.

6. An apparatus for demodulating signals received from a plurality of base stations including a serving base station and a neighbor base station, comprising:
a synchronization module that verifies whether or not the signals transmitted from the plurality of base stations are received by a terminal and determines start timings of the signals transmitted from the plurality of base stations;
a control module selecting a demodulation section on the basis of the start timings of the signals; and
a demodulation module demodulating a multicast signal included in the received signals on the basis of the demodulation section.

7. The apparatus of claim 6, wherein
the demodulation section is a section where the reception energy of the symbol has the maximum level among symbols corresponding to signals.

8. The apparatus of claim 6, wherein
the plurality of base stations include the serving base station and the plurality of neighbor base stations, and
the synchronization module
determines start timings of a serving cell signal transmitted from the serving base station and neighbor cell signals transmitted from the plurality of neighbor base stations.

9. The apparatus of claim 8, wherein
the control module
verifies whether or not the plurality of neighbor cell signals that are earlier than the serving cell signal are provided on the basis of the start timings of the serving cell signal and the neighbor cell signal.

10. The apparatus of claim 9, wherein
when the plurality of neighbor cell signals are received earlier than the serving cell signal,
a section where the reception energy of a multicast symbol has the maximum level among symbols of frames corresponding to the serving cell signal and the neighbor cell signal, is selected as the demodulation section.

11. The apparatus of claim 9, wherein,
when the sum of reception energies of the plurality of neighbor cell signals is larger than the reception energy of the serving cell signal,
a section where the reception energy of a unicast symbol has the maximum level and a section where the reception energy of a multicast symbol has the maximum level, and among symbols of frames corresponding to the serving cell signal and the neighbor cell signal, is selected as the demodulation section.

12. The apparatus of claim 9, wherein,
when the serving cell signal is received earlier than the plurality of neighbor cell signals, the demodulation section of the symbol is selected on the basis of the start timing of the serving cell signal.
